(19) United States
(12) Patent Application Publication
(10) Pub. No.: US 2021/0180501 A1
(43) Pub. Date: Jun. 17, 2021

(54) RING CATALYST

(71) Applicant: Vitesco Technologies Germany GMBH, Hannover (DE)

(72) Inventors: Marat Karibayev, Lohmar (DE); Klaus Müller-Haas, Köln (DE)

(73) Assignee: Vitesco Technologies Germany GMBH, Hannover (DE)

(21) Appl. No.: 17/189,708

(22) Filed: Mar. 2, 2021

Related U.S. Application Data
(63) Continuation of application No. PCT/EP2019/073172, filed on Aug. 30, 2019.

(30) Foreign Application Priority Data
Sep. 4, 2018 (DE) 10 2018 215 031.1

(51) Int. Cl. F01N 3/28

(52) U.S. Cl. CPC F01N 3/2892; F01N 3/2803

(57) ABSTRACT

A catalytic converter for the aftertreatment of exhaust gases from an internal combustion engine, with a first tubular central flow section, with a deflecting device for deflecting the flow direction and with an annular flow section which has at least one catalytically active matrix. The tubular flow section is formed by an inner jacket and the annular flow section is formed by an outer jacket surrounding the inner jacket, wherein the deflecting device is formed by a flat half-shell.

### CROSS-REFERENCE TO RELATED APPLICATIONS

This application claims priority to PCT Application PCT/EP2019/073172, filed Aug. 30, 2019, which claims priority to German Patent Application No. DE 10 2018 215 031.1, filed Sep. 4, 2018. The disclosures of the above applications are incorporated herein by reference.

### FIELD OF THE INVENTION

The invention relates to a catalytic converter for the aftertreatment of exhaust gases from an internal combustion engine, with a first tubular central flow section, with a deflecting device for deflecting the flow direction and with an annular flow section which has at least one catalytically active matrix.

### BACKGROUND OF THE INVENTION

Various types of catalytic converter are used for the aftertreatment of exhaust gases. What are referred to as ring catalytic converters are used in applications that are characterized by limited installation space and may have a short overall length. The ring catalytic converters have a central tubular flow section through which a flow passes first. Mixing of the exhaust gas takes place in the central tubular flow section.

After passing through the tubular flow section, the exhaust gas is diverted radially outward in a chamber connected to the flow section and deflected by a further 90 degrees such that the exhaust gas flows back in the direction opposite to the flow direction in the tubular flow section. The ring catalytic converter has an annular catalytically active matrix which is arranged annularly around the tubular flow section.

To achieve the greatest possible reduction in pollutants in the ring catalytic converter, a homogeneous flow distribution or concentration distribution of the exhaust gas in the flow sections of the ring catalytic converter and in the catalytically active matrix is necessary.

A ring catalytic converter of the type in question is known from EP 2 873 821 A1. The essential basic features such as the central tubular flow channel, the flow deflection and the annular catalyst matrix are known therefrom.

The deflecting devices of the ring catalytic converters known up to now in the prior art are not optimally designed in order to produce as homogeneous a flow and concentration distribution as possible. The flow and concentration distribution at the inlet cross section of the catalytically active matrix is not optimal here.

### SUMMARY OF THE INVENTION

It is therefore the object of the present invention to create a ring catalytic converter which is improved with regard to the uniform distribution of flow and uniform distribution of concentration and thus enables improved pollutant reduction rates.

The object with regard to the catalytic converter is achieved by a catalytic converter with the features described herein.

One exemplary embodiment of the invention relates to a catalytic converter for the aftertreatment of exhaust gases from an internal combustion engine, with a first tubular central flow section, with a deflecting device for deflecting the flow direction and with an annular flow section which has at least one catalytically active matrix, wherein the tubular flow section is formed by an inner jacket and the annular flow section is formed by an outer jacket surrounding the inner jacket, wherein the deflecting device is formed by a flat half-shell.

The tubular flow section and the annular flow section are preferably arranged concentrically with respect to one another. The flow is deflected from the tubular flow section into the annular flow section by a total of 180° such that the exhaust gas flows in opposite directions to one another in the two flow sections.

In an embodiment, the inner jacket and the outer jacket have an identically long extent in the axial direction or the main flow direction in the tubular flow section.

An identically long extent results in that there is no protrusion of the inner jacket over the outer jacket or vice versa in the axial direction of the catalytic converter.

It is also advantageous if an at least partially circumferentially encircling confusor is arranged on the end region of the inner jacket facing the deflecting device, for bundling the exhaust-gas flow. A confusor serves to concentrate the flow within the tubular flow section. For this purpose, the confusor may be a completely circumferential flow-directing element or else may be arranged only in sections in the circumferential direction. The confusor preferably contributes to a constriction of the flow cross section of the tubular flow section. The confusor parameters that are influenced are preferably the extent in the axial direction and the extent in the radial direction into the flow section.

It is also preferable if the confusor extends in the axial direction over a length m, wherein m may assume values in the range of 0.015≤m/D≤0.44, wherein D is the inner diameter of the outer jacket tube. It has been shown that such a size ratio of the confusor to the total width of the catalytic converter is able to achieve an optimal flow guidance in interaction with the deflecting device according to the invention.

In addition, it is advantageous if the catalytically active matrix is arranged in the annular flow section, wherein the inflow side of the matrix ends flush with the outer jacket. This is advantageous in order to achieve the best possible flow against the matrix. In this way, flow effects that could arise again, for example, in the annular flow channel, such as for example the formation of a laminar edge flow, are minimized.

It is also advantageous if the deflecting device has a first region which is arranged centrally above the central axis of the catalytic converter and is dome-shaped. The flow thus flows centrally against the first region. Ideally, the deflecting device is also oriented concentrically with the tubular flow channel such that the flow guidance by the deflecting device is as symmetrical as possible.

It is also expedient if the deflecting device has a second region which is formed by an annular depression. The annular depression forms a constriction of the flow cross section on the side of the deflecting device against which the flow flows, in interaction with the inner jacket, which promotes mixing of the flowing exhaust gas.

In addition, it is advantageous if the second region is arranged radially outside the inner jacket. This is advantageous so that the flow into the annular flow channel may take place as optimally as possible and the greatest possible uniform distribution of flow and uniform distribution of concentration is produced.

It is also expedient if the deflecting device has a third region which is arranged in the radial direction on the outer edge of the catalytic converter and is formed by an annular bulge. The third region serves as a turning aid for the transfer of the flow into the annular flow channel.

Various embodiments of the present invention are described in the following description of the Figures.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

In the following, the invention is explained in detail using exemplary embodiments with reference to the drawings. In the drawings:

FIG. 1 shows a plan view of the deflecting device;

FIG. 2 shows a sectional view through a ring catalytic converter according to the invention; and

FIG. 3 shows a further sectional view through a ring catalytic converter with a detailed illustration of the deflecting device.

### DETAILED DESCRIPTION OF THE PREFERRED EMBODIMENTS

The following description of the preferred embodiment(s) is merely exemplary in nature and is in no way intended to limit the invention, its application, or uses.

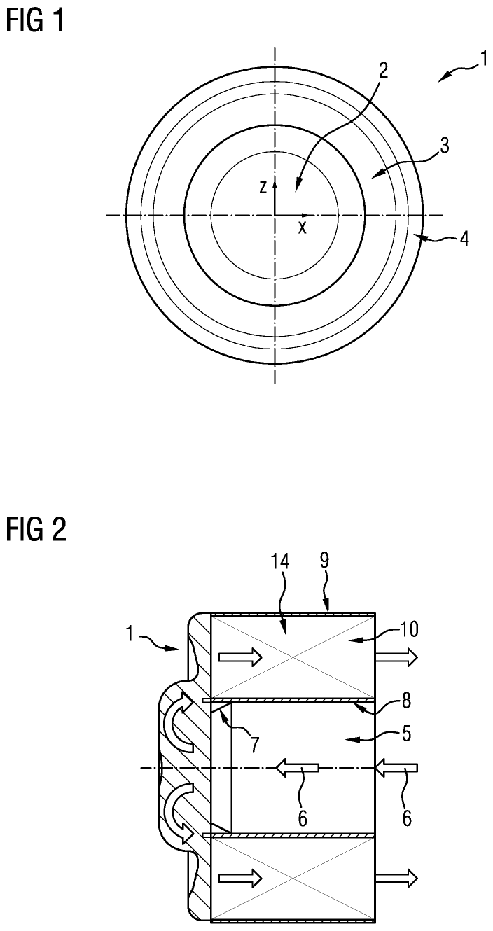

FIG. 1 shows a deflecting device formed by a half-shell 1. The half-shell has a first central depression 2 which is formed in the half-shell, for example by deep-drawing. In the radial direction, the first depression 2 is surrounded by a second annular depression 3. The annular depression 3 is adjoined in the radial direction by a bulge 4 which was formed in the half-shell 1 in the opposite direction to the depressions 2 and 3.

The half-shell 1 is connected to the outer jacket in a manner comparable to a cover in such a way that the inner surface of the half-shell 1 serves as a flow-directing element for the from the tubular flow section and the exhaust gas is thereby transferred into the annular outer flow section.

FIG. 2 shows a sectional view through a ring catalytic converter. The tubular central flow section 5 through which the exhaust gas flows along the arrows 6 is shown. A confusor 7 is arranged in the axial direction at the end of the flow section 5, the confusor 7 bundling the exhaust gas flowing in the flow section 5 and directing same in a targeted manner into the deflecting device formed by the half-shell 1.

FIG. 2 also shows that the inner jacket 8 forming the flow section 5 extends in the axial direction precisely as far as the outer jacket 9. There is no protrusion of the inner jacket 8 beyond the outer jacket 9 in the flow direction.

A catalytically active matrix 10 is arranged in the annular gap formed between the inner jacket 8 and the outer jacket 9. The inlet side of the catalytically active matrix 10 is preferably arranged flush with the end of the outer jacket 9 and the inner jacket 8 facing the deflecting device 1.

The exhaust gas flowing through the flow section 5 is diverted radially outward in the deflecting device 1 and finally by a further 90 degrees and is thus directed through the annular flow channel 14 between the inner jacket 8 and the outer jacket 9. After flowing through the catalytically active matrix 10, the exhaust gas may finally flow on via suitable flow paths.

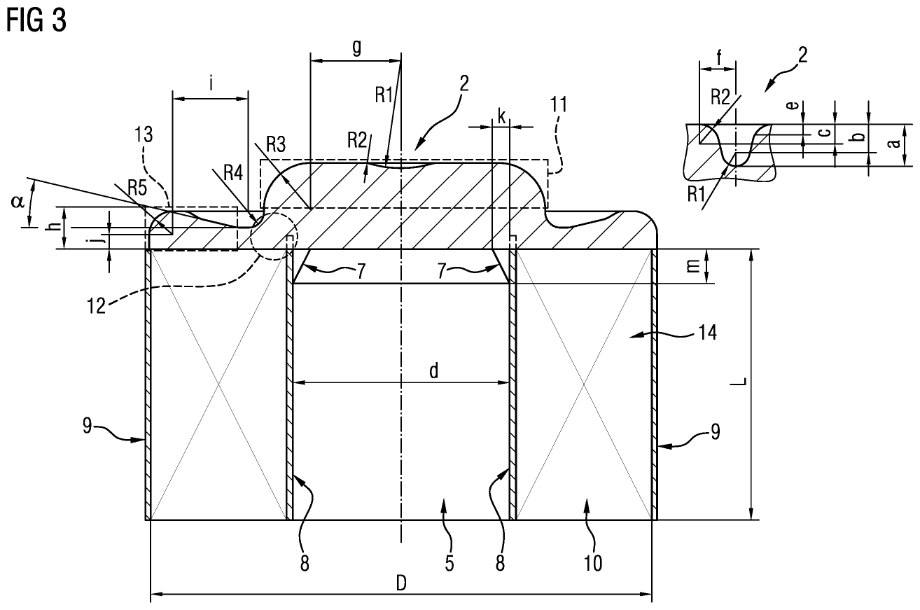

FIG. 3 shows a sectional view through a ring catalytic converter according to the invention, wherein the illustration in FIG. 3 shows an embodiment of the design of the deflecting device 1. According to the invention, the different radii of the depressions and bulges follow specific size ratios, as a result of which a desired flow deflection is achieved.

The deflecting device has a first region 11 which is arranged centrally in an extension of the tubular flow section 5. This first region 11 is dome-shaped and has a central circular depression 2. The depression 2 is described by a first radius R1, which describes the inner radius of the depression 2, and by a second radius R2, which describes the radius at the transition from the dome-shaped structure to the depression 2.

The upper right region of FIG. 3 shows a detailed view of the depression 2, which reveals in detail the ratio that is between the radii R1 and R2 and the further dimensions a, b, c, e and f.

For the radius R1, the latter is in a value range of 0.005≤R1/D≤0.33. The preferred value range of 0.005≤R2/D≤0.33 applies analogously for the radius R2. For the other dimensions a, c, e and f, which each describe lengths and distances between the points shown, the preferred value ranges are between 0.005≤a/D≤0.33; 0.005≤c/D≤0.33; 0.005≤e/D≤0.33; 0.01≤f/D≤0.25. For the dimension b, 0.005≤b/D≤0.33 applies.

Reference sign D denotes the diameter of the outer jacket 9 and reference sign d denotes the diameter of the inner jacket 8.

The dome-shaped region 11 of the deflecting device 1 is furthermore determined by the outer radius R3, which is in the value range 0.01≤R3/D≤0.14. The distance g in the radial direction between the central axis of the deflecting device and the beginning of the curvature with the radius R3 is determined via the relationship 0.13≤g/D≤0.27.

If this size specification for the geometry is adhered to, the result is a rotationally symmetrical division of the exhaust gas flow into a plurality of partial flows. The central depression facilitates the rotationally symmetrical division of the exhaust gas flow and thus contributes to the improved uniform distribution of flow on the inlet side of the catalytically active matrix 10.

The first region 11 is spaced from the end of the inner jacket 8 along the axial main flow direction in the flow section 5 by the distance h. The greatest length of the deflecting device along the central axis of the catalytic converter is determined via the value resulting from the dimension h and the radius R3. The value range for h is in the range of 0.016≤h/D≤0.16.

The width of the region 11 is determined by the dimension g and the radius R3 (2g+2R3) and is greater than the diameter d of the inner jacket 8, wherein d is in the range of 0.36≤d/D≤0.55.

The deflecting device 1 furthermore also has a second region 12, which adjoins the first region 11 in the radial direction and is formed by an annular depression. The radius R3 is adjoined by the radius R4, which is in the value range of 0.01≤R4/D≤0.11. The depression of the second region 12 primarily serves to produce a constriction of the annular cross section between the end region of the inner jacket 8 and the radially outer partial contour of the deflecting device 1. This constriction ensures an improved flow guidance toward the inlet side of the catalytically active matrix 10.

The deflecting device 1 also has a third region 13 which is located on the radial outer edge region. The third region is defined by the radius R5, which is in a value range of 0.01≤R5/D≤0.16. The beginning of the outer radius R5 is spaced from the axial end region of the outer jacket 9 or from the inlet side of the catalytically active matrix 10 by the distance j, which is in the value range 0.005≤j/D≤0.15. In the radial direction, the radius R5 is spaced from the central axis of the catalytic converter by the distance i+R4+R3+g.

From the annular depression with the radius R4 to the third region 13 and the radius R5, the outer contour of the deflecting device 1 increases along the extent i, which is in the value range of 0.05≤i/D≤0.25, by the angle α, wherein the angle α is in the range of 0.5°α25°.

This gradient of the contour achieves an expansion of the flow cross section, which serves to ensure that the flow forced in the regions 11 and 12 reaches the entire cross section of the catalytically active matrix 10 in the annular outer flow channel 14.

FIG. 3 also shows the confusor 7 in the inner jacket 8. The confusor 7 has a radial extent k, wherein the value range of k is defined as 0.01≤k/D≤0.11. Furthermore, the confusor 7 has an axial extent m, wherein m is in the value range of 0.015≤m/D≤0.44.

The confusor 7 thus tapers the inner cross section of the inner jacket 8 over the length m, starting from a radial extent from zero to the value k. The confusor 7 thus protrudes into, and tapers, the flow cross section of the inner jacket 8, as a result of which an improved uniform distribution of flow over the cross section of the catalytically active matrix 10 is achieved.

The exemplary embodiments in FIGS. 1 to 3 are not of a restrictive nature and serve to illustrate the inventive concept.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A catalytic converter for the aftertreatment of exhaust gases from an internal combustion engine, comprising:
an inner jacket;
an outer jacket;
a first tubular central flow section formed by the inner jacket;
an annular flow section which has at least one catalytically active matrix, the annular flow section is formed by the outer jacket surrounding the inner jacket; and
a deflecting device for deflecting the flow direction of exhaust gases;
wherein the deflecting device is formed by a flat half-shell, and the deflecting device is connected to the outer jacket.

2. The catalytic converter of claim 1, wherein the inner jacket and the outer jacket have an identically long extent in the axial direction or the main flow direction in the tubular central flow section.

3. The catalytic converter of either of claim 1, further comprising:
an at least partially circumferentially encircling confusor arranged on the end region of the inner jacket facing the deflecting device;
wherein the at least partially circumferentially encircling confusor bundles the exhaust-gas flow.

4. The catalytic converter of claim 3, wherein the confusor extends in the axial direction over a length m.

5. The catalytic converter of claim 4, wherein m assumes values in the range of 0.015≤m/D≤0.44, wherein D is the inner diameter of the outer jacket.

6. The catalytic converter of one of claim 1, wherein the catalytically active matrix is arranged in the annular flow section, such that the inflow side of the catalytically active matrix ends flush with the outer jacket.

7. The catalytic converter of one claim 1, the deflecting device further comprising a first region which is arranged centrally above the central axis of the catalytic converter and is dome-shaped.

8. The catalytic converter of claim 1, the deflecting device further comprising a second region which is formed by an annular depression.

9. The catalytic converter of claim 8, wherein the second region is arranged radially outside the inner jacket.

10. The catalytic converter of claim 1, the deflecting device further comprising a third region which is arranged in the radial direction on the outer edge of the catalytic converter and is formed by an annular bulge.
